(19) United States
(12) Patent Application Publication
(10) Pub. No.: US 2007/0027261 A1
(43) Pub. Date: Feb. 1, 2007

(54) Composition comprising asphalt and epoxy (Meth)acrylate copolymer

(76) Inventors: George Wyatt Prejean, Orange, TX (US); Felipe Sanchez-Chavez, San Luis Potosi (MX); Gregg Byron Babcock, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/495,950

(22) Filed: Jul. 28, 2006

Related U.S. Application Data
(60) Provisional application No. 60/703,526, filed on Jul. 28, 2005.

(51) Int. Cl. C08L 37/00

(52) U.S. Cl. 525/206

(57) ABSTRACT

Disclosed is a composition comprising or produced from asphalt, a first ethylene copolymer, and optionally a second ethylene copolymer, a polymer comprising repeat units derived from styrene, a sulfur source, or combinations of two or more thereof wherein the first ethylene copolymer comprises repeat units derived from ethylene and an epoxy-containing comonomer and the second ethylene copolymer comprises ethylene and an ester of an unsaturated carboxylic acid. Also disclosed is a process for making an asphalt composition having improved R&B softening points.

This application claims priority to U.S. provisional application No. 60/703526, filed Jul. 28, 2005, the entire disclosure of which is incorporated herein by reference.

The invention relates to a composition comprising asphalt and an ethylene copolymer comprising epoxy (meth)acrylate and having increased asphalt softening points.

### BACKGROUND OF THE INVENTION

Some asphalt sold for paving is modified with polymers to improve rut resistance, fatigue resistance, cracking resistance, and can improve stripping resistance (from aggregate) resulting from increases in asphalt elasticity and stiffness. Asphalts are performance graded (PG) by a set of specifications developed by the US federal government (Strategic Highway Research Program or SHRP). For example a PG58-34 asphalt provides good rut resistance at 58° C. (determined by AASHTO (American Association of State Highway Transportation Officials)) and good cold cracking resistance at −34° C. Addition of polymer to asphalt increases the higher number (provides higher temperature rut resistance) and improves fatigue resistance. Good low temperature properties are to a large extent dependent on the specific asphalt composition (e.g., flux oil content, penetration index), but the polymer type does influence low temperature performance. The asphalt industry considers polymers for asphalt modification to be either elastomers or plastomers. Generally elastomeric polymers improve low temperature performance and plastomeric polymers decrease it. The word plastomer indicates a lack of elastomeric properties. Plastomers are sometimes used to modify asphalt because they can increase stiffness and viscosity which improves rut resistance but they are generally considered inferior to elastomers due to lack of significant improvements in fatigue resistance, creep resistance, cold crack resistance, etc. SBS (styrene/butadiene/styrene block copolymer) and DuPont (E. I. du Pont de Nemours and Company, Wilmington, Del., USA) Elvaloy® RET (ethylene/butyl acrylate/glycidyl methacrylate terpolymer; ENBAGMA) are considered elastomers. Polyethylene (PE) and ethylene vinyl acetate (EVA) resins are considered plastomers. PE is not miscible with asphalt, consequently asphalt modified with it must be continuously stirred to prevent separation. Asphalt modified with PE must be prepared at the mix plant and cannot be shipped due to separation. PE therefore acts as filler and does not meaningfully increase the softening point of asphalt. DuPont Elvaloy® RET resins (ENBAGMA) are excellent modifiers for asphalt and improve asphalt performance at low concentrations (1 wt % to 2 wt %). The improvement in asphalt properties with addition of Elvaloy® at such low concentrations may be due to a chemical reaction between the Elvaloye and the functionalized polar fraction of asphalt (asphaltenes). Superphosphoric acid (SPA) is sometimes added to reduce the reaction time with asphalt. Addition of acid can be a negative in some cases (e.g., customer perception that acid is bad, intolerance to amine antistrips). The reaction occurs with heat alone but takes it longer (6-24 hours without acid and 3-6 hours with acid) and the resultant polymer modified asphalt (PMA) is not as elastic (as evidenced by a higher phase angle and low elastic recovery). Some PMA producers prefer acid and some prefer heat. Heat reaction does eliminate the problem with amine antistrips.

Elvaloy® AC available from DuPont are ethylene acrylate copolymers (e.g., ethylene/butyl acrylate copolymers) produced in a tubular process. These resins give an immediate increase in the upper PG value, impart a high degree of elasticity to asphalt, and act more as an elastomer than as a plastomer, though it may reduce low temperature performance. Ethylene acrylate copolymers produced in an autoclave process perform strictly as plastomers when added to asphalt (they increase stiffness but not elasticity).

We determined that the combination of Elvaloy® AC and Elvaloy® RET is synergistic and provides the advantages of both resins. These blends are mainly used without acid and provide an immediate increase in upper PG, are not sensitive to amine antistrip, impart high elasticity to asphalt and do not adversely affect low temperature performance. Also concentrates of the blends can be made with essentially no risk of gelling. With Elvaloy® RET alone there is a risk of gelling when producing concentrates.

High softening points (as measured by the Ring and Ball test; R&B softening point) are required in parts of the world such as Asia and Europe. For example, R&B softening points as high as 80° C. are required in China. Ethylene copolymers impart many good properties to asphalt, but do not impart high softening points. SBS (styrene/butadiene/styrene block copolymer) can impart high R&B values to asphalt but it requires very high concentrations. In addition, SBS tends to separate from the asphalt at these higher concentrations.

Therefore, there is a need to provide an asphalt composition having increased R&B softening points for PMA modified with ethylene copolymers, and comprising miscible PE-like resin as well as a means of modifying an asphalt with a PE-like resin without adversely affecting low temperature toughness of the modified asphalt.

### SUMMARY OF THE INVENTION

A composition comprising or produced from asphalt, a first ethylene copolymer, and optionally a second ethylene copolymer, a polymer comprising repeat units derived from styrene, a sulfur source, an acid, or combinations of two or more thereof wherein the first ethylene copolymer comprises repeat units derived from ethylene and an epoxy-containing comonomer.

### DETAILED DESCRIPTION OF THE INVENTION

Asphalt can be obtained as a residue in the distillation or refining of petroleum or can be naturally occurring, as is the case with Trinidad Lake asphalt. Chemically it is a complex mixture of hydrocarbons, which can be separated into two major fractions, asphaltenes and maltenes. The asphaltenes are polycyclic aromatics and most contain functionality (some or all of the following functionalities are present; carboxylic acids, amines, sulfides, sulfoxides, sulfones, sulfonic acids, porphrin rings chelated with V, Ni and Fe). The maltenes phase contains polar aromatics, aromatics, naphthene. It is generally believed that asphalt is a colloidal dispersion with the asphaltenes dispersed in the maltenes; the dispersing agent being the polar aromatics. The asphaltenes are relatively high in molecular weight (about 1500) as compared with the other components of asphalt. The asphaltenes are amphoteric (acid and base on same molecule) in nature and form aggregates through self-association that offer some viscoelastic behavior to asphalt. Asphaltenes vary in amount and functionality depending on the crude source from which the asphalt is derived.

All asphalts containing asphaltenes can be used. The asphalt can be of low or high asphaltene content. The asphaltene content can be from about 0.01 to about 30, about 0.1 to about 15, about 1 to about 10, or about 1 to about 5%, by weight. Examples of asphalts include Wyoming Sour, Mayan, Venezuelan, Canadian, Arabian, Trinidad Lake, and combinations of two or more thereof.

Asphalts can be diluted with flux oils (e.g., Hydrolene® flux oil) to obtain about 100 to about 350 or about 200 to about 300 pen asphalts and to improve low temperature properties (e.g., preventing low temperature cracking) for pavements in cold climates. Flux oils can encompass many types of oils used to modify asphalt and are the final products in crude oil distillation. They are non-volatile oils that are blended with asphalt to soften it. They can be aromatic, paraffinic or naphthenic (e.g., Sonoco offers 19 different flux oils such as Hydrolene®). Pen (short for penetration) is one means of characterizing asphalts. High pen grades are soft asphalts (e.g., 300 pen is a very soft asphalt). Normally pen is determined at 25° C. by ASTM D5. It is the distance in tenths of one mm that a needle under a load of 100 grams penetrates the asphalt in 5 seconds. Under these circumstances, the asphaltene concentration in the composition can range from about 0.0001 to about 1 wt % such that the asphalt can react with the ethylene copolymer but may not react with either acids such as SPA catalyst or heat (see, e.g., U.S. Pat. No. 6,117,926).

A modified asphalt may also be used. For example, a sulfonated asphalt or salt thereof (e.g., sodium salt), an oxidized asphalt, or combinations thereof may be used in combination of the asphalt disclosed above.

The first ethylene copolymer can comprise, consist essentially of, or consist of, repeat units derived from ethylene and an epoxy comonomer including, for example, a glycidyl esters of acrylic acid or methacrylic acid, glycidyl vinyl ether, or combinations thereof where the comonomer may be incorporated into the first ethylene copolymer from about 0.5 to about 16% or about 5% to about 12%. The comonomer can include carbon monoxide, glycidyl acrylate, glycidyl methacrylate, glycidyl butyl acrylate, glycidyl vinyl ether, or combinations of two or more thereof. For example, an E/GMA is a copolymer comprising repeat units derived from ethylene and glycidyl methacrylate. The first ethylene copolymer can optionally include repeat units derived from an ester of unsaturated carboxylic acid such as (meth)acrylate or C₁ to C₈ alkyl (meth)acrylate, or combinations of two or more thereof. “(Meth)acrylate”, refers to acrylate, alkyl acrylate, methacrylate, or combinations of two or more thereof.

The second ethylene copolymer can comprise, consist essentially of, or consists of, repeat units derived from ethylene and an ester of unsaturated carboxylic acid such as that disclosed above.

Examples of alkyl acrylates include methyl acrylate, ethyl acrylate and butyl acrylate. For example, “ethylene/methyl acrylate (EMA)” means a copolymer of ethylene and methyl acrylate (MA); “ethylene/ethyl acrylate (EEA)” means a copolymer of ethylene and ethyl acrylate (EA); “ethylene/butyl acrylate (EBA)” means a copolymer of ethylene and butyl acrylate (BA); and includes both n-butyl acrylate and iso-butyl acrylate; and combinations of two or more thereof.

Alkyl (meth)acrylate comonomer incorporated into ethylene copolymer can vary from 0.01 or 5 up to as high as 40 weight % of the total copolymer or even higher such as from 5 to 30, or 10 to 25, wt %.

The second ethylene copolymer may contain about 15 to about 40, or about 18 to about 35, wt % of acrylate comonomer. Increasing acrylate comonomer may improve the elastomeric properties and increase the tackiness of the copolymer. The ethylene copolymer may have a melt index (MI) of from about 0.1 to about 100, or about 0.5 to about 20, or about 0.5 to about 10, g/10 min, measured with ASTM D-1238, condition E (190° C., 2160 gram weight).

The first and second ethylene copolymers are well known. For example, “ethylene acrylate copolymers” may also be referred to as ethylene-acrylic acid ester copolymers. They can be manufactured from two high-pressure free radical processes: tubular processes or autoclave processes. The difference in ethylene acrylate copolymers made from the two processes is described in, e.g., “High flexibility EMA made from high pressure tubular process.” Annual Technical Conference—Society of Plastics Engineers (2002), 60^{th} (Vol. 2), 1832-1836. The ethylene acrylate copolymer produced from the tubular process is preferred in the invention herein.

Also for example, ethylene, an alkyl (meth)acrylate such as methyl acrylate, and optionally a solvent such as methanol (see U.S. Pat. No. 5,028,674) are fed continuously into a stirred autoclave of the type disclosed in U.S. Pat. No. 2,897,183, together with an initiator. Similarly, ethylene and an epoxy comonomer can be fed continuously in an autoclave to produce the first ethylene copolymer.

Tubular reactor-produced ethylene copolymer can be distinguished from the more conventional autoclave produced ethylene as well known in the art. Thus the term or phrase “tubular reactor produced” ethylene copolymer denotes an ethylene copolymer produced at high pressure and elevated temperature in a tubular reactor or the like, wherein the inherent consequences of dissimilar reaction kinetics for the respective ethylene and alkyl (meth)acrylate (e.g. methyl acrylate) comonomers is alleviated or partially compensated by the intentional introduction of the monomers along the reaction flow path within the tubular reactor. Such a tubular reactor copolymerization technique can produce a copolymer having a greater relative degree of heterogeneity along the polymer backbone (a more blocky distribution of comonomers), tend to reduce the presence of long chain branching, and produce a copolymer characterized by a higher melting point than one produced at the same comonomer ratio in a high pressure stirred autoclave reactor.

Tubular reactor produced ethylene/(meth)acrylate copolymers of this nature are commercially available from DuPont.

The manufacturing of the tubular reactor ethylene/(meth)acrylate copolymers is well known to one skilled in the art such as disclosed in U.S. Pat. Nos. 3,350,372; 3,756,996; and 5,532,066, the disclosures of which are incorporated herein for the interest of brevity.

The composition can also include a polymer comprising repeat units derived from styrene, can be any known polymer comprising repeat units derived from styrene and a diene such as SBS block copolymer. The “B” segment of the SBS block polymer is a diene poly-segment which can be a conjugated diene having 4-6 carbons atoms such as 1,3-butadiene, isoprene, 2-ethyl-1,3-butadiene, 2,3-dimethyl-1,3-butadiene and piperylene. The “S” segment of the block copolymer is a monovinyl aromatic polysegment. Examples of such are styrene, α-methylstyrene, p-vinyltoluene, m-vinyltoluene, o-vinyltoluene, 4-ethylstyrene, 3-ethylstyrene, 2-ethylstyrene, 4-tert-butylstyrene and 2,4-dimethylstyrene. SBS block copolymer is a tri-block polymer having a polystyrene segment at the ends of the molecule and an elastomeric segment - a conjugated diene in the center of the block polymer. For paving application, the wt % range of polystyrene may range from about 10 to about 50 or about 20 to 40%. SBS copolymers are available commercially from, e.g., Kraton Polymers (Houston, Tex., USA), Enichem (Houston, Tex., USA), and ConocoPhillips (Houston, Tex., USA).

SB is a random copolymer (also known as SBR) comprising repeat units derived from styrene and butadiene in which styrene and butadiene are randomly dispersed in the polymer molecule.

SB and SBS can be made by anionic polymerization. For example, random SB can be made in a solution process. The details of the process for production can be found for example in a Nexant ChemSystems Report published Dec. 3, 2003 (Nexant is in San Francisco, Calif., USA). Both SBS block copolymer and SB random copolymer are commercially available from, e.g., Dutch State Mines, Netherlands (DSM), Sartomer (Exton, Pa., USA) and Goodyear (Akron, Ohio, USA). Diblock SB can also be used in this invention. Preferred wt % polystyrene range is the same as for SBS.

These diblock and triblock copolymers based on styrene and butadiene can be prepared by conventional procedures such as those described in U.S. Pat. No. 3,281,383 and U.S. Pat. No. 3,639,521.

The composition can further optionally include a sulfur source such as element sulfur, a sulfur donor, a sulfur byproduct, or combinations of two or more thereof. A sulfur donor generates sulfur in-situ when included in the composition. Examples of sulfur donors include sodium diethyldithiocarbamate, 2,2-dithiobis(benzothiazole),mercaptobenzothiazole, dipentamethylenethiuram tetrasulfide, or combinations of two or more thereof and include Sasobit® TXS (a proprietary product available from Sasol Wax Americas, Shelton, Conn., USA). A sulfur byproduct can include one or more sulfonic acids, sulfides, sulfoxides, sulfones, or combinations of two or more thereof.

The composition can comprise or be produced from about 0.01 to about 10 wt %, or about 0.1 to about 6 wt %, or about 0.5 to about 4 wt % of one or more first ethylene copolymers. Optionally the composition can include about 0.01 to about 20 wt %, or about 0.1 to about 10 wt %, or about 0.5 to about 5 wt % of one or more second ethylene copolymers; and about 0.001 to about 5 wt %, or about 0.005 to about 2 wt %, or about 0.01 to about 0.5 wt % of sulfur source (based on the available sulfur content). If a copolymer comprising units derived from styrene and butadiene (styrene/butadiene copolymer) is employed, the copolymer can be present in the composition in the range from about 0.01 to about 10 wt %, or about 0.1 to about 5 wt %, or about 0.5 to about 2 wt %. The remainder can be asphalt.

The composition can comprise about 0.001 to about 10, or about 0.01 to about 5, or about 0.05 to about 3, or about 0.1 to about 2 wt % of an acid. Inorganic acid or organic acid can be used such as mineral acids, sulfonic acids, carboxylic acids, or combinations of two or more thereof. An example of the acid frequently used is superphosphoric acid disclosed above. The acid can be similarly combined with asphalt and other component as disclosed above.

The composition can have an R&B softening point of > about 80° C.

The composition can be produced by, for example, combining the asphalt, both ethylene copolymers, and the optional sulfur source and/or styrene/butadiene copolymer in a mixer by dry blending or by the conventional masterbatch technique, or the like. The combinations can be subject to a condition including heating to a range of about 150 to about 250° C., or about 170 to 225° C., or to molten stage in any suitable vessel such as a mixing tank or a reactor or a metal can. An aromatic flux oil disclosed above can also be added to the asphalt to produce a softer asphalt. The ethylene copolymers and the optional styrene/butadiene copolymer or sulfur, in any physical form such as pellets, can be added to the molten asphalt to produce a molten mixture.

The molten mixture can be heated at about 150 to about 250° C., or about 170 to 225° C. under a pressure that can accommodate the temperature range, such as atmospheric pressure, for about 1 to about 35 hours, or about 2 to about 30 hours, or about 5 to about 25 hours.

The molten mixture can be mixed by, for example, a mechanical agitator or any other mixing means.

PMAs are normally produced in a high sheer mill process, or in a low sheer mixing process, as is well known to one skilled in the art. For example, process used is dependant on the equipment available, and on the polymers used. Polymers that can be used in low sheer mixing equipment can be used in high sheer equipment also. Either type of equipment can be used with this invention. A solvent may or may not be used to disperse polymers that are typically used in high sheer equipment into asphalt by using low sheer equipment. A good example on how PMA can be produced commercially can be found in publications IS-200, from the Asphalt Institute, Lexington, Ky.

The invention can be used anytime an elastomeric modification of asphalt is desired. This modified asphalt composition can be mixed with aggregates at a ratio of about 1 to about 10 or about 5% asphalt, about 90 to about 99 or about 95% aggregates and used for paving. Polymer-modified asphalts can be used for paving of highways, city streets, parking lots, ports, airfields, sidewalks, and many more. Polymer-modified asphalts can also be used as a chip seal, emulsions, or other repair product for paved surfaces.

The asphalt composition disclosed here can also be used as a roofing or waterproofing product. Highly modified asphalt can be used to adhere various roofing sheets to roofs or used as a waterproofing covering for many roofing fabrics. The modified asphalt can then be used in road pavement applications, or in roofing applications, or in any other application typically using an elastomeric modified asphalt.

### EXAMPLES

All blends (polymer modified asphalts or PMA's) were prepared in a 1000 ml metal can. Total weight of the blend mixture was 500 g. The polymers were added to the base asphalt (percentage was based on the total weight of the blend mixture) as shown in the tables. The blend mixture was stirred with a three paddle stirrer at 300 rpm for 4 hours at ˜400° F. (204.4° C.) at atmospheric pressure. Tests were performed on the PMA's according to ASTM and ASSHTO methods well known to one skilled in the art

The results show that base asphalt had an R&B softening point substantially lower than 80° C. whereas Examples 1-6 show that the invention blends had an 80° C. or higher R&B softening point by combining an E/GMA polymer to base asphalt. Comparative examples 1-7 show that ethylene copolymers without epoxy repeat units failed to improve R&B softening points except Comparative Example 7, which comprised sulfur. Comparative examples 5-7 indicate that high levels of SBS were required to increase R&B softening points. These comparative examples also show that at these high levels SBS separated from the asphalt. The results further show that E/GMA did not adversely affect good low temperature toughness as evidenced by the good m values and it did not separate from asphalt. E/GMA also provided high elasticity as evidenced by the low phase angles.

TABLE 1*

| | CS | Test | Base | Ex 1 | Ex 2 | Ex 3 | Ex 4 |
|---|---|---|---|---|---|---|---|
| | | | | 13 | 15 | 35 | 30 |
| Penetration, 25° C. (mm) | >40 | ASTM D5 | 54 | 83 | 73.4 | | |
| Ductility, 5° C. (cm) | >20 | ASTM D113 | 0 | 36.2 | 37.8 | 35 | 13.5 |
| R&B Softening Point (° C.) | >80 | ASTM D32 | 56 | 81.11 | 80.8 | 80 | 84 |
| Storage Stability | <2.5 | ASTM D32 | | 0 | 0.3 | | |
| (2 days@163° C.) - | | | | | | | |
| Difference in SP R&B top | | | | | | | |
| and bottom temp (° C.) | | | | | | | |
| Elastic Recovery, 25° C. (%) | >70 | ASTM D226 | 10 | 87 | 90 | 87 | 82 |
| Upper PG grading (DSR) (° C.) | 76-22 | AASHTO TP5 | 64 | 76 | 76 | 76 | 82 |
| PG pass/fail (DSR) (° C.) | no spec | AASHTO TP5 | 67.9 | 77.5 | 77 | 76 | 83.1 |
| Phase Angle (DSR) (degrees) | no spec | AASHTO TP5 | 88.6 | 55 | 57.6 | 58.3 | 52.8 |
| Lower PG grading (BBR) (° C.) | −22 | AASHTO TP1 | | −28 | −28 | | |
| BBR; m (slope) | >0.3 | AASHTO TP1 | | 0.309 | 0.333 | | |
| BBR; S (Mpa) | <300 | AASHTO TP1 | | 100 | 107 | | |

*CS, China specs;
Base, base asphalt;
Ex 1 (Example 1; 3.5 wt % 3135 + 2 wt % E/GMA);
Ex 2 (Example 2; 3 wt % 3135 + 1.8 wt % E/GMA);
Ex 3 (Example 3; 3.3 wt % 3135 + 1.5 wt % E/GMA);
Ex 4 (Example 4; 3 wt % 3427 + 1.8 wt % E/GMA);
3135 was an ethylene butyl acrylate copolymer containing 35 wt % butyl acrylate produced in a tubular process, MI = 1;
E/GMA was an ethylene glycidyl methacrylate copolymer produced in an autoclave process, MI = 4; and
BBR denotes Bending Beam Rheometer (3 point bend test).

TABLE 2**

| | CS | Test | Base | CE 1 | CE 2 | CE 3 | CE 4 | CE 5 | CE 6 | CE 7 |
|---|---|---|---|---|---|---|---|---|---|---|
| Penetration, 25° C. (mm) | >40 | ASTM D5 | 54 | 51 | 54 | 51 | | | | |
| Ductility, 5° C. (cm) | >20 | ASTM D113 | 0 | 29.2 | | 50.8 | | 72.8 | 62 | 44.5 |
| R&B Softening Point (° C.) | >80 | ASTM D32 | 56 | 69.3 | 62.6 | 57.4 | 60 | 68.5 | 78.8 | 84 |
| Storage Stability | <2.5 | ASTM D32 | | 11.9 | | | | | 32.6 | 29.4 |
| (2 days@163° C.) - | | | | | | | | | | |
| Difference in SP R&B top | | | | | | | | | | |
| and bottom temp (° C.) | | | | | | | | | | |
| Elastic Recovery, 25° C. (%) | >70 | ASTM D226 | 10 | 84 | | | 62 | | 98 | 98 |
| Upper PG grading (DSR) (° C.) | 76-22 | AASHTO TP5 | 64 | 70 | 64 | 70 | 76 | 70 | 76 | 76 |
| PG pass/fail (DSR) (° C.) | no spec | AASHTO TP5 | 67.9 | 74.7 | 69.5 | 73.8 | 76.9 | 75 | 80.9 | 79.6 |
| Phase Angle (DSR) (degrees) | no spec | AASHTO TP5 | 88.6 | 70.4 | 75.6 | 79.3 | 77.3 | 69.1 | 57.8 | 65.5 |
| Lower PG grading (BBR) (° C.) | −22 | AASHTO TP1 | | −28 | | | | | | |
| BBR; m (slope) | >0.3 | AASHTO TP1 | | 0.319 | | | | | | |
| BBR; S (Mpa) | <300 | AASHTO TP1 | | 124 | | | | | | |

**See also Table 1 for footnotes;
CE 1 (Comparative Example 1; 4.5 wt % 3135);
CE 2 (Comparative Example 2; 3.5 wt % 3135;
CE 3 (Comparative Example 3; 2 wt % Kraton 1101 + 2 wt % 3135);
CE 4 (Comparative Example 4; 2 wt % 3135 + 0.75 wt % 1001 + 0.3 wt % SPA);
CE 5 (Comparative Example 5; 4.7 wt % Kraton 1101);
CE 6 (Comparative Example 6; 6 wt5 Kraton 1101);
CE 7 (Comparative Example 7; 6 wt % Kraton 1101 + 0.1 wt % Sulfur);
3427 is an ethylene butyl acrylate copolymer containing 35 wt % butyl acrylate produced in a tubular process, MI = 4; and
Kraton 1101 is a linear SBS triblock copolymer supplied by Kraton Chemical with contains 31 wt % polystyrene, MI < 1.

TABLE 3***

| | | | | Example | Example |
|---|---|---|---|---|---|
| | CS | Test | Base | 5 | 6 |
| Ductility, | >20 | ASTM D226 | 3 | 85 | 85 |
| 5° C. (cm) | | | | | |
| R&B Softening | >80 | ASTM D32 | 51 | 88 | 93 |
| Point (° C.) | | | | | |

***See also Table 1 for footnotes; Base asphalt ws 50/70 Pen Hungarian asphalt
Example 5 composition included 2 wt % E/GMA (no acid) in base asphalt; and Example 6 composition included 2 wt % E/GMA + 0.2 wt % SPA in base asphalt.

1. A composition comprising or produced from asphalt, a first ethylene copolymer, and optionally a second ethylene copolymer, a polymer comprising repeat units derived from styrene, a sulfur source, an acid, or combinations of two or more thereof wherein the first ethylene copolymer comprises repeat units derived from ethylene and a comonomer including carbon monoxide, an epoxy-containing comonomer, or combinations thereof and the second ethylene copolymer comprises ethylene and an ester of an unsaturated carboxylic acid.

2. The composition of claim 1 wherein the comonomer includes glycidyl acrylate, glycidyl methacrylate, glycidyl butyl acrylate, glycidyl vinyl ether, or combinations of two or more thereof.

3. The composition of claim 2 wherein the comonomer is glycidyl methacrylate.

4. The composition of claim 1 wherein the composition comprises or is produced from asphalt and about 0.01 to about 10 wt %, optionally about 0.1 to about 6 wt %, of one or more of the first ethylene copolymers.

5. The composition of claim 3 wherein the composition comprises or is produced from asphalt and about 0.5 to about 4 wt % of one or more of the first ethylene copolymers.

6. The composition of claim 1 wherein the composition further comprising the sulfur source; the sulfur source includes element sulfur, a sulfur donor, a sulfur byproduct, or combinations of two or more thereof; and the composition optionally comprises about 0.001 to about 5 wt % of sulfur source, based on the available sulfur content.

7. The composition of claim 6 wherein the comonomer is glycidyl methacrylate and the composition comprises about 0.001 to about 5 wt % of sulfur source.

8. The composition of claim 7 wherein the composition comprises or is produced from asphalt and about 0.5 to about 4 wt % of one or more of the first ethylene copolymers and the composition comprises about 0.005 to about 2 wt %, optionally about 0.01 to about 0.5 wt %, of sulfur source.

9. The composition of claim 1 further comprising about 0.01 to about 10 wt % of the polymer comprising repeat units derived from styrene.

10. The composition of claim 1 further comprising about 0.1 to about 5 wt %, optionally about 0.5 to about 2 wt %, of the polymer comprising repeat units derived from styrene

11. The composition of claim 8 further comprising about 0.5 to about 2 wt % of the polymer comprising repeat units derived from styrene.

12. The composition of claim 1 further comprising an acid and about 0.001 to about 10 wt % of the second polymer, and the acid is optionally superphosphoric acid.

13. The composition of claim 6 further comprising an acid and about 0.01 to about 5 wt % of the second polymer, and the acid is superphosphoric acid.

14. The composition of claim 11 further comprising an acid and about 0.05 to about 2 wt % of the second polymer, and the acid is superphosphoric acid.

15. The composition of claim 1 comprising asphalt and a copolymer of ethylene and glycidyl methacrylate.

16. The composition of claim 14 wherein the first ethylene copolymer is a copolymer of ethylene and glycidyl methacrylate.

17. A process comprising contacting asphalt with a mixture, which comprises a first ethylene copolymer, and optionally a second ethylene copolymer, a polymer comprising repeat units derived from styrene, a sulfur source, or combinations of two or more thereof wherein the first ethylene copolymer, the second ethylene copolymer, the sulfur source, and the polymer comprising repeat units derived from styrene are each as characterized as in claim 1.

18. A road pavement or roofing sheet comprising a composition wherein the composition comprises or is produced from asphalt, a first ethylene copolymer, and optionally a second ethylene copolymer, a polymer comprising repeat units derived from styrene, a sulfur source, an acid, or combinations of two or more thereof wherein the first ethylene copolymer comprises repeat units derived from ethylene and an epoxy-containing comonomer and the second ethylene copolymer comprises ethylene and an ester of an unsaturated carboxylic acid.

19. The road pavement or roofing sheet of claim 18 wherein the composition comprises or is produced from asphalt and about 0.01 to about 10 wt %, optionally about 0.1 to about 6 wt %, of one or more of the first ethylene copolymers; the comonomer includes carbon monoxide, glycidyl acrylate, glycidyl methacrylate, glycidyl butyl acrylate, glycidyl vinyl ether, or combinations of two or more thereof; and the composition comprises about 0.005 to about 2 wt %, optionally about 0.01 to about 0.5 wt %, of sulfur source.

20. The road pavement or roofing sheet of claim 19 wherein the comonomer is glycidyl methacrylate; the composition of claim 1 further comprises about 0.01 to about 10 wt % of the polymer comprising repeat units derived from styrene and the sulfur; and the sulfur source is sulfur.
